(19) United States
(12) Patent Application Publication
(10) Pub. No.: US 2016/0047962 A1
(43) Pub. Date: Feb. 18, 2016

(54) METHOD FOR PRODUCING OPTICALLY ANISOTROPIC FILM

(71) Applicant: SUMITOMO CHEMICAL COMPANY, LIMITED, Tokyo (JP)

(72) Inventor: Tadahiro KOBAYASHI, Osaka-shi, Osaka (JP)

(21) Appl. No.: 14/783,302

(22) PCT Filed: Apr. 10, 2014
(86) PCT No.: PCT/JP2014/060885

§ 371 Date: Oct. 8, 2015

(30) Foreign Application Priority Data
Apr. 11, 2013 (JP) 2013-082698

(51) Int. Cl. G02B 5/30; G02F 1/1335

(52) U.S. Cl. CPC G02B 5/3083; G02F 1/133528; G02B 5/3041

(57) ABSTRACT

A method is provided for producing an optically anisotropic film. The method includes the following steps: (1) a step of coating a composition for forming an optically anisotropic layer onto a surface of a substrate, or onto a surface of an orientation layer formed on the surface of the substrate; (2) a step of drying the coated composition for forming an optically anisotropic layer to form a dry coating; and (3) a step of cooling the dry coating at a rate of 6° C./sec or more to form an optically anisotropic film.

### TECHNICAL FIELD

The present invention relates to a method for producing an optically anisotropic film.

### BACKGROUND ART

A flat panel display device (FPD) makes use of a member including an optically anisotropic film such as a polarizing plate or a retardation plate. As such an optically anisotropic film, known is an optically anisotropic film produced by coating a composition containing liquid crystal compound onto a substrate. For example, Patent Document 1 describes a method for producing an optically anisotropic film including coating a composition containing liquid crystal compound onto a substrate subjected to orienting treatment, and drying the coated composition. However, the conditions in drying the coated composition are not described.

### PRIOR ART DOCUMENT

### Patent Document

Patent Document 1: JP-A-2007-148098

### SUMMARY OF THE INVENTION

### Problems to be Solved by the Invention

According to the conventional method for producing an optically anisotropic film, there has been a problem that transparency of the resultant optically anisotropic film is reduced, due to occurrence of orientation unevenness.

### Means for Solving the Problems

The present invention encompasses the following inventions.

[1] A method for producing an optically anisotropic film including the following steps (1) to (3):
(1) a step of coating a composition for forming an optically anisotropic layer onto a surface of a substrate, or a surface of an orientation layer formed on the surface of the substrate; (2) a step of drying the coated composition for forming an optically anisotropic layer to form a dry coating; and (3) a step of cooling the dry coating at a rate of 6° C./sec or more to form an optically anisotropic film.
[2] The method for producing an optically anisotropic film according to item [1], including, after cooling at a rate of 6° C./sec or more to form an optically anisotropic film, further gradually lowering the cooling rate.
[3] The method for producing an optically anisotropic film according to item [1] or [2], further including a step of (4) a step of photoirradiating the optically anisotropic film.
[4] The method for producing an optically anisotropic film according to any of items [1] to [3], wherein the time from the start of cooling at a rate of 6° C./sec or more until gradually lowering the cooling rate and reaching a cooling rate of 0.5° C./sec is 2 seconds to 10 minutes.
[5] The method for producing an optically anisotropic film according to any of items [1] to [4], wherein the substrate is a roll-form substrate, and the steps (1) to (3) are continuously performed.
[6] The method for producing an optically anisotropic film according to any of items [1] to [5], wherein the steps (2) and (3) are performed while blocking out light.
[7] The method for producing an optically anisotropic film according to item [5] or [6], wherein cooling was performed by bringing a surface reverse to the surface on which the orientation layer of the substrate is formed into contact with only an air layer and a guide roll, and cooling was performed by bringing a surface of the dry coating into contact with only an air layer.
[8] An optically anisotropic film obtained by performing the following steps (1) to (3):
(1) a step of coating a composition for forming an optically anisotropic layer onto a surface of a substrate, or a surface of an orientation layer formed on the surface of the substrate;
(2) a step of drying the coated composition for forming an optically anisotropic layer to form a dry coating; and
(3) a step of cooling the dry coating at a rate of 6° C./sec or more to form an optically anisotropic film.
[9] The optically anisotropic film according to item [8], the film having a retardation property.
[10] The optically anisotropic film according to item [8] or [9], the film being for an in-plane switching (IPS) liquid crystal display device.
[11] A polarizing plate having the optically anisotropic film according to any of items [8] to [10].
[12] A display device including the optically anisotropic film according to any of items [8] to [10].

### Effect of the Invention

According to the present invention, an optically anisotropic film excellent in transparency can be produced.

### BRIEF DESCRIPTION OF THE DRAWINGS

FIGS. 1(a) to 1(e) are each a cross-sectional schematic view showing an example of the polarizing plate according to the present invention.

FIGS. 2(a) and 2(b) are each a cross-sectional schematic view showing an example of the liquid crystal display device according to the present invention.

FIG. 3 is a graph showing a temperature change of a dry coating in Examples.

### MODE FOR CARRYING OUT THE INVENTION

The method for producing an optically anisotropic film of the present invention includes the following steps (1) to (3):

(1) a step of coating a composition for forming an optically anisotropic layer onto a surface of a substrate, or a surface of an orientation layer formed on the surface of the substrate;
(2) a step of drying the coated composition for forming an optically anisotropic layer to form a dry coating; and
(3) a step of cooling the dry coating at a rate of 6° C./sec or more to form an optically anisotropic film.
The method may further include a step of (4) a step of photoirradiating the optically anisotropic film.

### [Substrate]

A transparent substrate is usually used as the substrate. The transparent substrate means a substrate having such a translucency that light, in particular, visible rays can be transmitted through the substrate. Translucency denotes a property that the transmittance to light rays having wavelengths from 380 nm to 780 nm is 80% or more. Specific examples of the transparent substrate include glass and translucent resin substrates, and preferred is a translucent resin substrate. As the substrate, a substrate in a film form is usually used. Among them, a film roll substrate in which unwinding and winding are possible in a roll-to-roll manner is particularly preferred in productivity.

Examples of the resin that constitutes the translucent resin substrate include polyolefins such as polyethylene, polypropylene, and norbornene-based polymers; polyvinyl alcohol; polyethylene terephthalate; polymethacrylates; polyacrylates; cellulose esters; polyethylene naphthalate; polycarbonates; polysulfones; polyethersulfones; polyetherketones; polyphenylenesulfides; polyphenylene oxides; and the like. Preferred are polyolefins such as polyethylene, polypropylene and norbornene-based polymers, polyethylene terephthalate, and polymethacrylates. More preferred are such polyolefins.

The substrate may be subjected to surface treatment. Examples of the method for the surface treatment include a method of treating a surface of the substrate with corona or plasma in a vacuum or an atmospheric pressure; a method of treating a surface of the substrate with a laser; a method of treating a surface of the substrate with ozone; a method of subjecting a surface of the substrate to saponifying treatment or a method of subjecting a surface of the substrate to flame treatment; a method of coating a coupling agent onto a surface of the substrate to subject to primer treatment; a graft-polymerization method of causing a reactive monomer or a polymer having reactivity to adhere onto a surface of the substrate, and then irradiating the monomer or the polymer with radial rays, plasma or ultraviolet rays to cause a reaction of the monomer or polymer; and the like. Among them, preferred is the method of treating a surface of the substrate with corona or plasma in a vacuum or an atmospheric pressure.

Examples of the method of treating a surface of the substrate with corona or plasma include

a method of setting the substrate between opposed electrodes under a pressure close to the atmospheric pressure, and generating corona or plasma to treat the surface of the substrate therewith;

a method of causing a gas to flow into the gap between opposed electrodes, making the gas into plasma between the electrodes, and blowing the plasma-state gas onto the substrate; and

a method of generating glow discharge plasma under a low pressure to treat the surface of the substrate therewith.

Among them, preferred are the method of setting the substrate between opposed electrodes under a pressure close to the atmospheric pressure, and then generating corona or plasma to treat the surface of the substrate therewith, and the method of causing a gas to flow into the gap between opposed electrodes, making the gas into plasma between the electrodes, and blowing the plasma-state gas onto the substrate. Usually, these surface treatments with corona or plasma can be conducted in a commercially available surface treatment apparatus.

An orientation layer is preferably formed on the surface of the substrate. Examples of the method for forming an orientation layer on the surface of the substrate include a method using an orienting polymer in which orientation regulating force is given by coating only or rubbing the surface, a method using a photo-orienting polymer in which orientation regulating force is given by irradiating the surface of the substrate with polarized light; a method of vapor-depositing silicon oxide obliquely onto the surface of the substrate; a method of forming a monomolecular film having a long chain alkyl group using the Langmuir-Blodgett method (LB method); and the like. Preferred is a method using an orienting polymer, from the viewpoint of orientation uniformity of the liquid crystal compound and productivity.

Examples of the orienting polymer include polyamides and gelatins, which each have amide bonds in the molecule, polyimides, which each have imide bonds in the molecule, polyamic acids, which are each a hydrolyzate of a polyimide, polyvinyl alcohols, alkyl-modified polyvinyl alcohols, polyacrylamides, polyoxazoles, polyethyleneimines, polystyrenes, polyvinyl pyrrolidones, polyacrylic acids, polyacrylates, and the like. These polymers may be used alone, or may be a composition obtained by combining plural kinds of polymers, or a copolymer obtained by combining plural kinds of polymers. These polymers can be easily obtained by polycondensation such as dehydration and dealcoholization, chain polymerization such as radical polymerization, anion polymerization and cation polymerization, coordination polymerization, ring-opening polymerization or the like.

Examples of the commercially available orienting polymer include SUNEVER (registered trademark, manufactured by Nissan Chemical Industries, Ltd.), OPTMER (registered trademark, manufactured by JSR Corporation), and the like.

The orientation layer composed of such orienting polymer facilitates the liquid crystal orientation of the liquid crystal compound. In accordance with the kind of the orienting polymer, or rubbing conditions, various liquid crystal orientations such as horizontal orientation, vertical orientation, hybrid orientation and oblique orientation can be controlled, and in the present invention, an orienting polymer vertically orienting liquid crystal compound and rubbing conditions are applied.

Examples of the method for the rubbing include a method of bringing a rubbing-cloth-wound rubbing roll that is being rotated into contact with the orienting polymer on the transported substrate mounted on a stage.

The photo-orienting polymer includes a polymer having a photosensitive structure. When the polymer having a photosensitive structure is irradiated with polarized light, the photosensitive structure in the irradiated portion is isomerized or crosslinked such that the photo-orienting polymer is oriented, and orientation regulating force is given to a layer made of the photo-orienting polymer. Examples of the photosensitive structure include an azobenzene structure, a maleimide structure, a chalcone structure, a cinnamic acid structure, a 1,2-vinylene structure, a 1,2-acetylene structure, a spiropyran structure, a spirobenzopyrane structure, a fulgide structure, and the like. The photo-orienting polymer forming an orientation layer may be used alone, or may be a combination of a plurality of polymers having different structures, or a copolymer having a plurality of different photosensitive structures. The photo-orienting polymer can be obtained by polycondensation such as dehydration and dealcoholization, chain polymerization such as radical polymerization, anion polymerization and cation polymerization, coordination polymerization, ring-opening polymerization or the like, of a monomer having a photosensitive structure. Examples of the photo-orienting polymer include photo-orienting polymers described in Japanese Patent Nos. 4450261 and 4011652, JP-A-2010-49230, Japanese Patent No. 4404090, JP-A-2007-156439, JP-A-2007-232934, and the like. Among them, as the photo-orienting polymer, a polymer forming a crosslinked structure by polarized light irradiation is preferred, from the viewpoint of durability.

Examples of the method for irradiating polarized light include a method using a device described in JP-A-2006-323060. In addition, a patterned orientation layer can be also formed by repeatedly irradiating each region with polarized light such as linear polarized ultraviolet rays, via a photomask corresponding to a plurality of desired regions. As the photomask, one provided with a shielding pattern on a film such as quartz glass, soda lime glass or polyester is usually used. Exposing light is shielded in the portion covered with the shielding pattern, and exposing light is transmitted in the portion not being covered. Quartz glass is preferred in that the influence of thermal expansion is small. The light to be irradiated is preferably ultraviolet ray, from the viewpoint of reactivity of the photo-orienting polymer.

The orienting polymer and the photo-orienting polymer are usually coated onto the surface of the substrate as a composition for forming an orientation layer dissolved in a solvent.

Examples of the solvent include water; alcohol solvents such as methanol, ethanol, ethylene glycol, isopropyl alcohol, propylene glycol, methylcellosolve, and butylcellosolve; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, methyl isobutyl ketone, and N-methyl-2-pyrrolidone; aliphatic hydrocarbon solvents such as pentane, hexane, and heptane; aromatic hydrocarbon solvents such as toluene, xylene, and chlorobenzene; nitrile solvents such as acetonitrile; ether solvents such as propylene glycol monomethyl ether, tetrahydrofuran, and dimethoxyethane; halogenated hydrocarbon solvents such as chloroform; and the like. Such organic solvents may be used alone or in combination.

The content of the solvent contained in the composition for forming an orientation layer is usually 10 parts by mass to 100000 parts by mass, preferably 1000 parts by mass to 50000 parts by mass, and more preferably 2000 parts by mass to 20000 parts by mass, related to 100 parts by mass of the solid content.

Examples of the method for coating a composition for forming an orientation layer onto the surface of the substrate include extrusion coating, direct gravure coating, reverse gravure coating, CAP coating, die coating methods, and the like. Also, examples include a method of the coating using a coater such as a dip coater, a bar coater, or a spin coater.

After coating the composition for forming an orientation layer onto the surface of the substrate, it is preferred to dry the coated composition to remove the solvent.

Examples of the drying method include natural drying, ventilation drying, heat drying, and reduced-pressure drying; and any combination of these methods. The drying temperature is preferably from 10° C. to 250° C., and more preferably from 25° C. to 200° C. The drying time, which depends on the kind of the solvent, is preferably from 5 seconds to 60 minutes, and more preferably from 10 seconds to 30 minutes.

The thickness of the orientation layer is usually from 10 nm to 10000 nm, and preferably from 10 nm to 1000 nm. It is preferred when the thickness of the orientation layer is in the above range, since the liquid crystal compound can be oriented in the desired direction or angle on the orientation layer.

### [Composition for Forming Optically Anisotropic Layer]

The composition for forming an optically anisotropic layer contains liquid crystal compound and a solvent. The liquid crystal compound are preferable polymerizable liquid crystal compound. The polymerizable liquid crystal compound refer to liquid crystal compound having a polymerizable group.

### [Liquid Crystal Compound]

Examples of the liquid crystal compound include a compound containing a group represented by a formula (X) (hereinafter, may be referred to as the “compound (X)”).

P¹¹-B¹¹-E¹¹-B¹²-A¹¹-B¹³- (X)

wherein P¹¹ represents a polymerizable group or a hydrogen atom;

A¹¹ represents a bivalent alicyclic hydrocarbon group or bivalent aromatic hydrocarbon group provided that any hydrogen atom contained in the bivalent alicyclic hydrocarbon group and bivalent aromatic hydrocarbon group is optionally substituted with a halogen atom, an alkyl group having 1 to 6 carbon atoms, an alkoxy group having 1 to 6 carbon atoms, a cyano group or a nitro group provided that any hydrogen atom contained in the alkyl group having 1 to 6 carbon atoms or the alkoxy group having 1 to 6 carbon atoms is optionally substituted with a fluorine atom;

B¹¹ represents —O—, —S—, —CO—O—, —O—CO—, —O—CO—O—, —CO—NR¹⁶—, —NR¹⁶—CO—, —CO—, —CS— or a single bond wherein R¹⁶s each represent a hydrogen atom or an alkyl group having 1 to 6 carbon atoms;

B¹² and B¹³ each independently represent —C≡C—, —CH═CH—, —CH₂—CH₂—, —O—, —S—, —C(═O)—, —C(═O)—O—, —O—C(═O)—, —O—C(═O)—O—, —CH═N—, —N═CH—, —N═N—, —C(═O)—NR¹⁶—, —NR¹⁶—C(═O)—, —OCH₂—, —OCF₂—, —CH₂O—, —CF₂O—, —CH═CH—C(═O)—O—, —O—C(═O)—CH═CH—, or a single bond;

E¹¹ represents an alkanediyl group having 1 to 12 carbon atoms provided that any hydrogen atom contained in the alkanediyl group is optionally substituted with an alkoxy group having 1 to 5 carbon atoms provided that any hydrogen atom contained in the alkoxy group is optionally substituted with a halogen atom; and also, any —CH₂— that constitutes the alkanediyl group is optionally replaced with —O— or —CO—.

The number of the carbon atoms of the aromatic hydrocarbon group and alicyclic hydrocarbon group as A¹¹ is preferably in the range of 3 to 18, more preferably in the range of 5 to 12, and particularly preferably 5 or 6. A¹¹ is preferably a cyclohexane-1,4-diyl group or a 1,4-phenylene group.

E¹¹ is preferably a linear alkanediyl group having 1 to 12 carbon atoms. Any —CH₂— that constitutes the alkanediyl group is optionally replaced with —O—.

Specific examples thereof include linear alkanediyl groups having 1 to 12 carbon atoms, such as methylene, ethylene, propane-1,3-diyl, butane-1,4-diyl, pentane-1,5-diyl, hexane-1,6-diyl, heptane-1,7-diyl, octane-1,8-diyl, nonane-1,9-diyl, decane-1,10-diyl, undecane-1,11-diyl, and dodecane-1,12-diyl groups; —CH₂—CH₂—O—CH₂—CH₂—, CH₂—CH₂—O—CH₂—CH₂—O—CH₂—CH₂—, and —CH₂—CH₂—O—CH₂—CH₂—O—CH₂—CH₂—O—CH₂—CH₂—; and the like. B¹¹ is preferably —O—, —S—, —CO—O—, or —O—CO—, and more preferably —CO—O—.

B¹² and B¹³ are each independently preferably —O—, —S—, —C(═O)—, —C(═O)—O—, —O—C(═O)—, or —O—C(═O)—O—, and more preferably —O— or —O—C(═O)—O—.

P¹¹ is preferably a polymerizable group. The polymerizable group is preferably a radical polymerizable group or cation polymerizable group in that the group is high in polymerization reactivity, in particular, photopolymerization reactivity. The polymerizable group is preferably a group represented by any one of the following formulae (P-11) to (P-15) since the liquid crystal compound having the group are easy to handle, and is also easily produced:

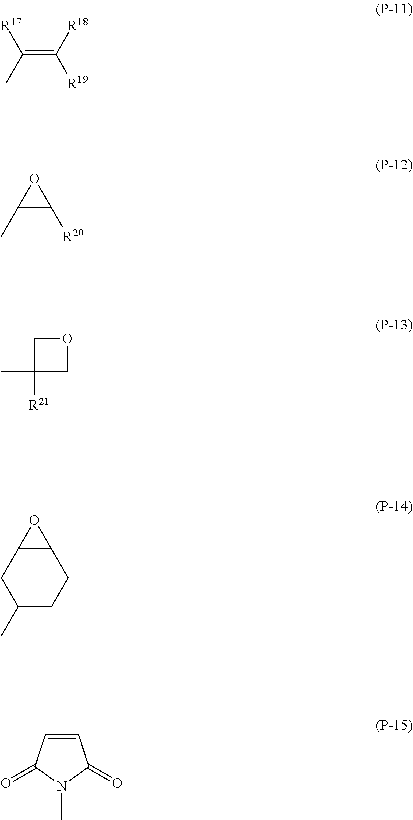

wherein

R¹⁷ to R²¹ each independently represent an alkyl group having 1 to 6 carbon atoms, or a hydrogen atom.

Specific examples of the group represented by any one of the formulae (P-11) to (P-15) include respective groups represented by the following formulae (P-16) to (P-20):

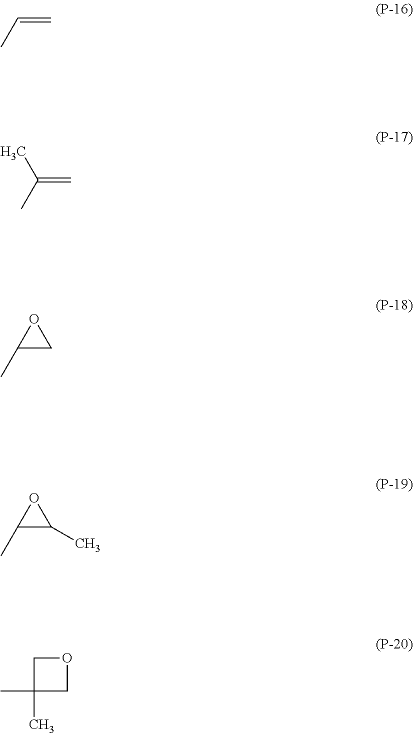

P¹¹ is preferably a group represented by any one of the formulae (P-14) to (P-20), and more preferably a vinyl, p-stilbene group, epoxy or oxetanyl group.

Further preferably, the group represented by P¹¹-B¹¹- is an acryloyloxy or methacryloyloxy group.

Examples of the compound (X) include respective compounds represented by the formulae (I), (II), (III), (IV), (V) or (VI):

P¹¹-B¹¹-E¹¹-B¹²-A¹¹-B¹³-A¹²-B¹⁴-A¹³-B¹⁵-A¹⁴-B¹⁶-E¹²-B¹⁷-P¹² (I)

P¹¹-B¹¹-E¹¹-B¹²-A¹¹-B¹³-A¹²-B¹⁴-A¹³-B¹⁵-A¹⁴-F¹¹ (II)

P¹¹-B¹¹-E¹¹-B¹²-A¹¹-B¹³-A¹²-B¹⁴-A¹³-B¹⁵-E¹²-B¹⁷-P¹² (III)

P¹¹-B¹¹-E¹¹-B¹²-A¹¹-B¹³-A¹²-B¹⁴-A¹³-F¹¹ (IV)

P¹¹-B¹¹-E¹¹-B¹²-A¹¹-B¹³-A¹²-B¹⁴-E¹²-B¹⁷-P¹² (V)

P¹¹-B¹¹-E¹¹-B¹²-A¹¹-B¹³-A¹²-F¹¹ (VI)

wherein

A¹² to A¹⁴ each independently have the same meaning as A¹¹; B¹⁴ to B¹⁸ each independently have the same meaning as B¹²; B¹⁷ has the same meaning as B¹¹; and E¹² has the same meaning as E¹¹; and

F¹¹ represents a hydrogen atom, an alkyl group having 1 to 13 carbon atoms, an alkoxy group having 1 to 13 carbon atoms, a cyano group, a nitro group, a trifluoromethyl group, a dimethylamino group, a hydroxy group, a methylol group, a formyl group, a sulfo group (—SO₃H), a carboxy group, an alkoxycarbonyl group having 1 to 10 carbon atoms, or a halogen atom, provided that any —CH₂— that constitutes the alkyl group and alkoxy group is optionally replaced with —O—.

Specific examples of the liquid crystal compound include compounds described in “3.8.6 Network (Completely Crosslinked Type)” and “6.5.1 Liquid Crystal Material, b. Polymerizable Nematic Liquid Crystal Material” in “Liquid Crystal Handbook” (edited by Liquid Crystal Handbook Editorial Committee, and published by Maruzen Publishing Co., Ltd. on Oct. 30, 2000); liquid crystal compound described in JP-A-2010-31223, JP-A-2010-270108, JP-A-2011-6360, and JP-A-2011-207765.

Specific examples of the compound (X) include compounds represented by following formulae (I-1) to (I-4), formulae (II-1) to (II-4), formulae (III-1) to (III-26), formulae (IV-1) to (IV-26), formulae (V-1) to (V-2), and formulae (VI-1) to (VI-6). In the following formulae, k1 and k2 each independently represent an integer of 2 to 12. These compounds (X) are preferred in that the compounds are easily synthesized or are easily available.

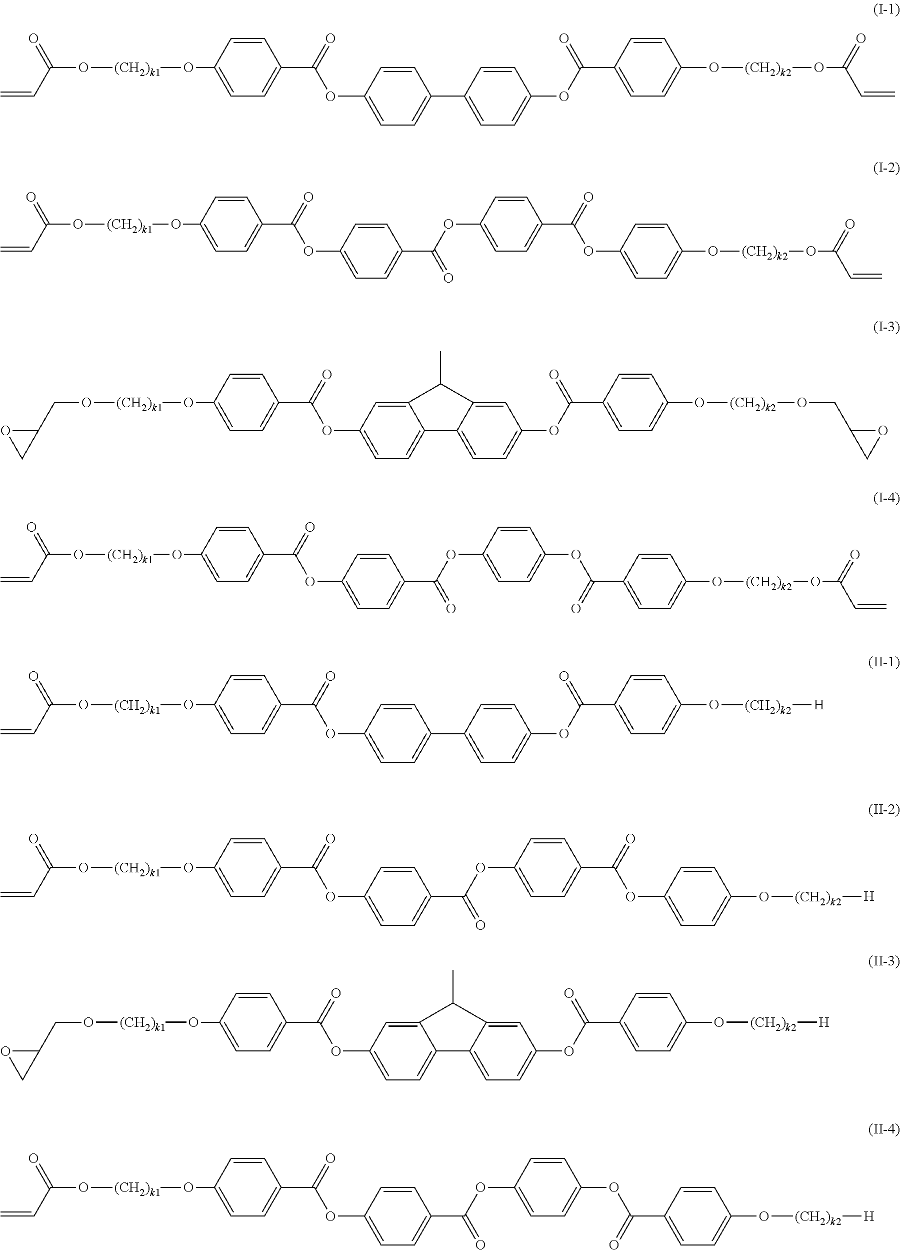

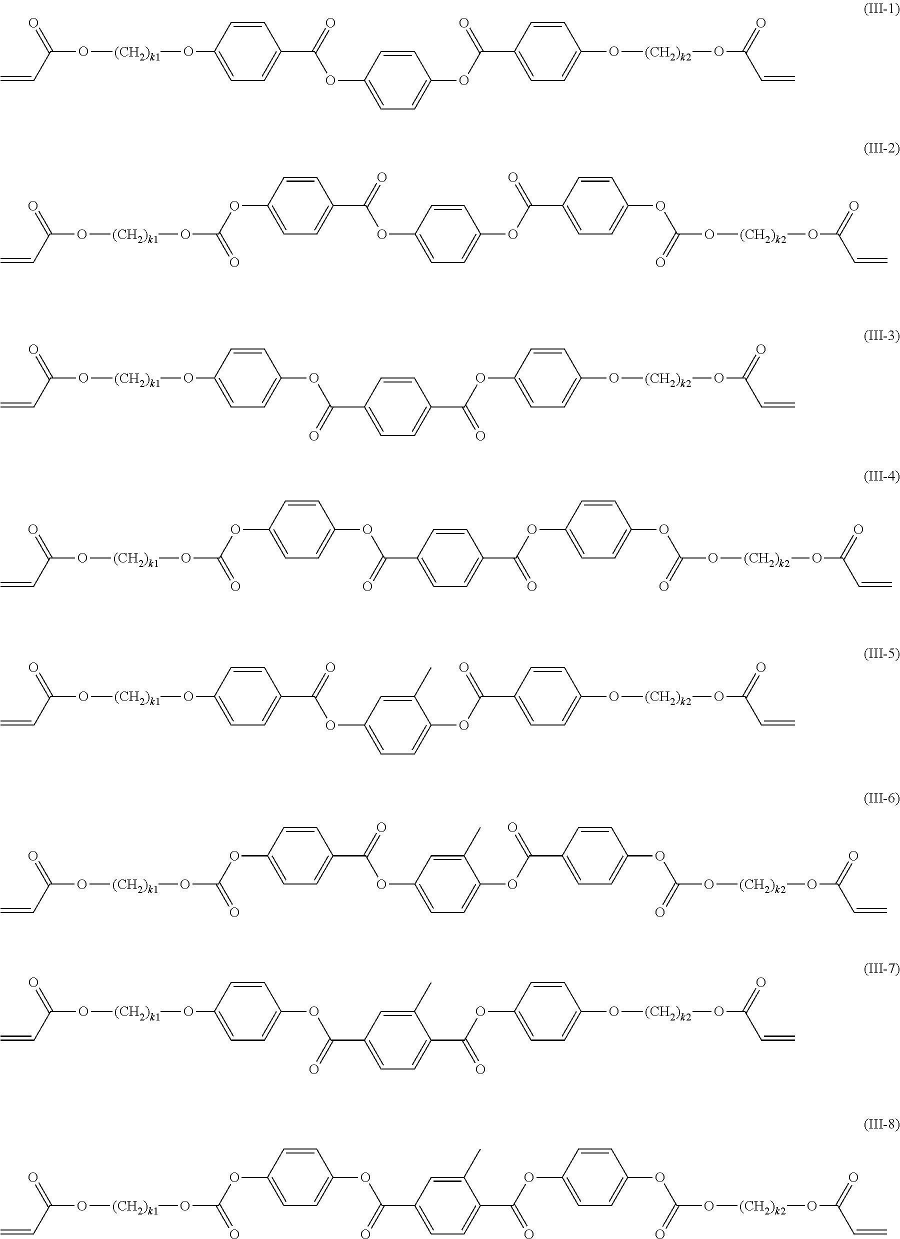

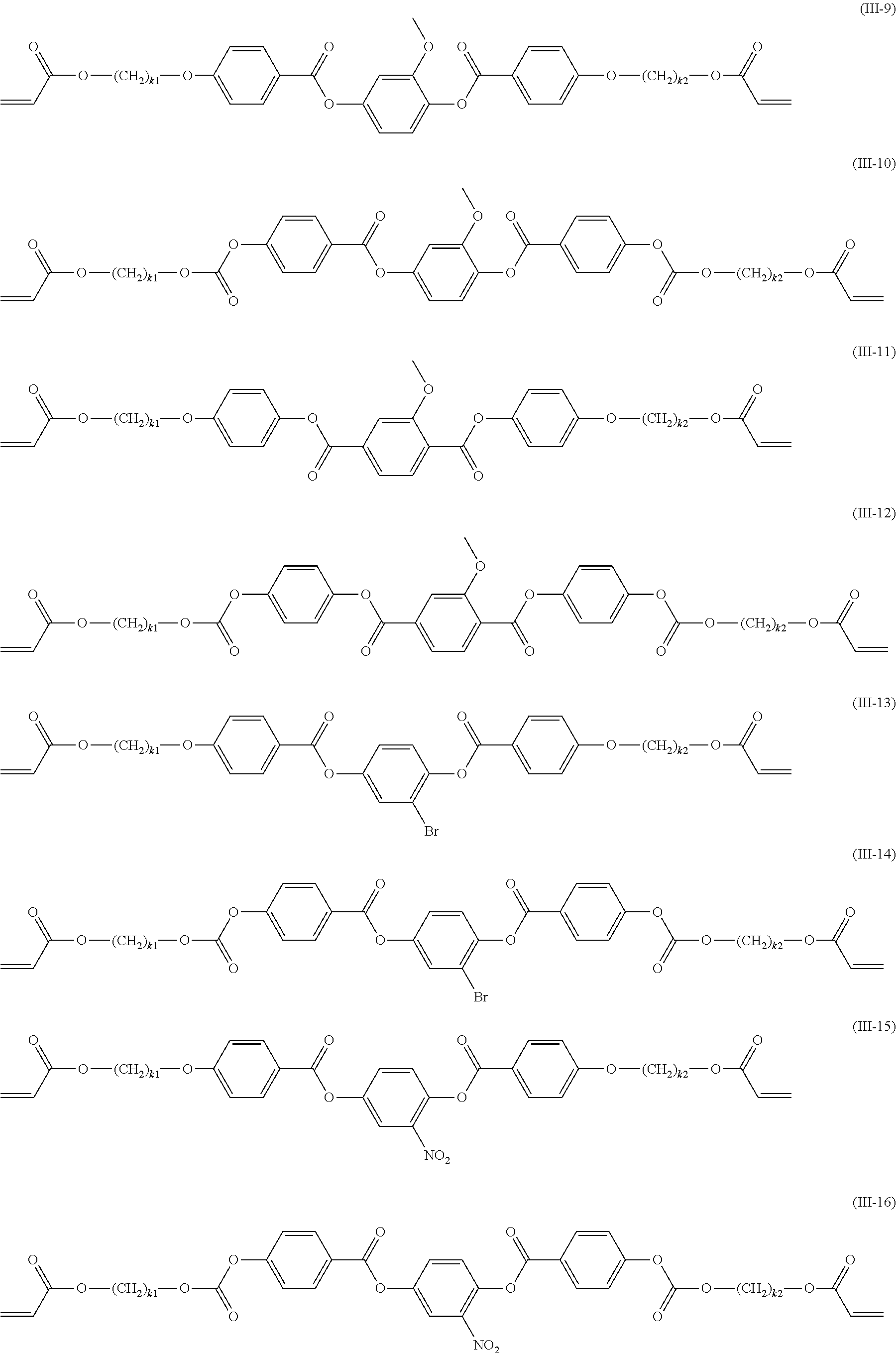

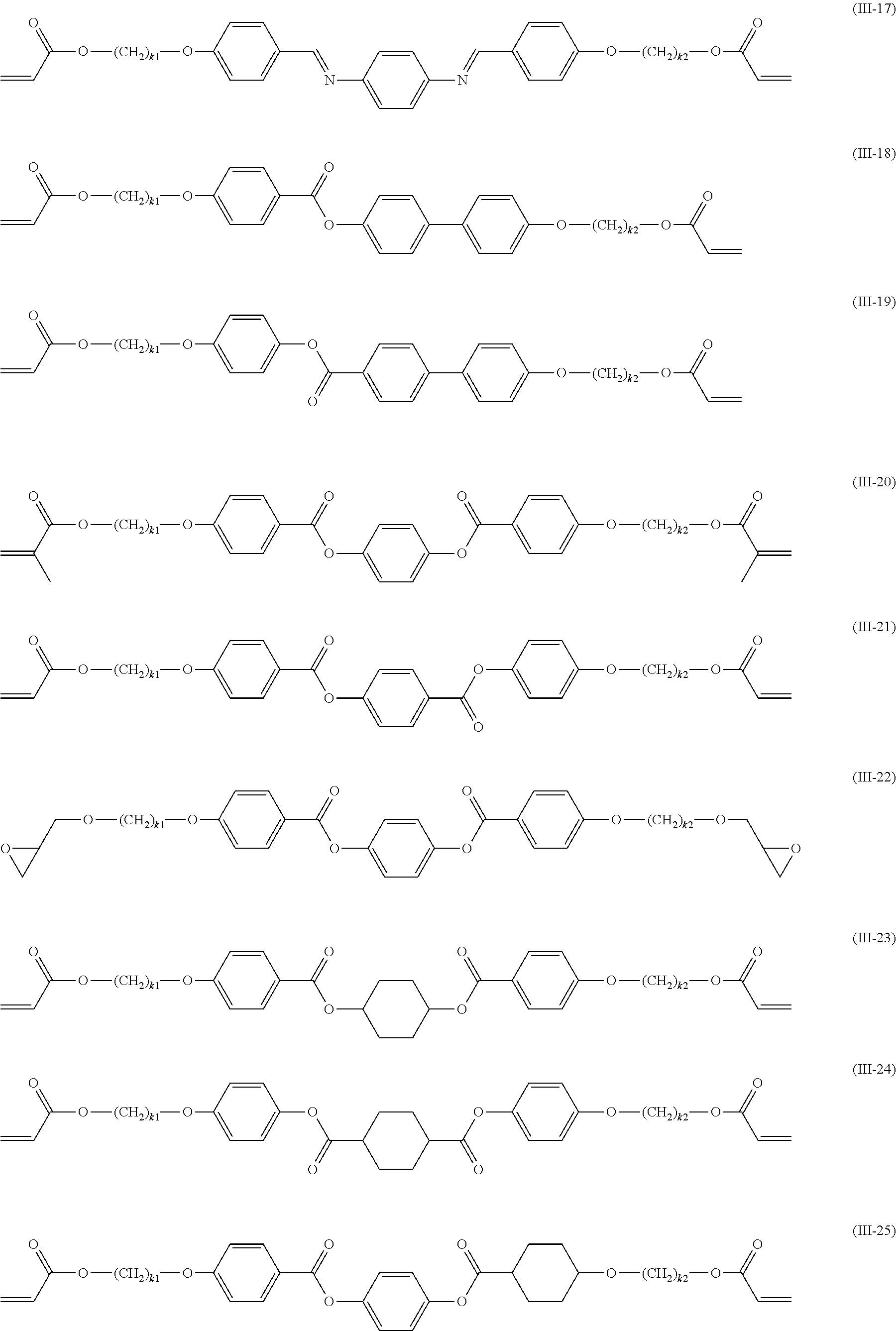

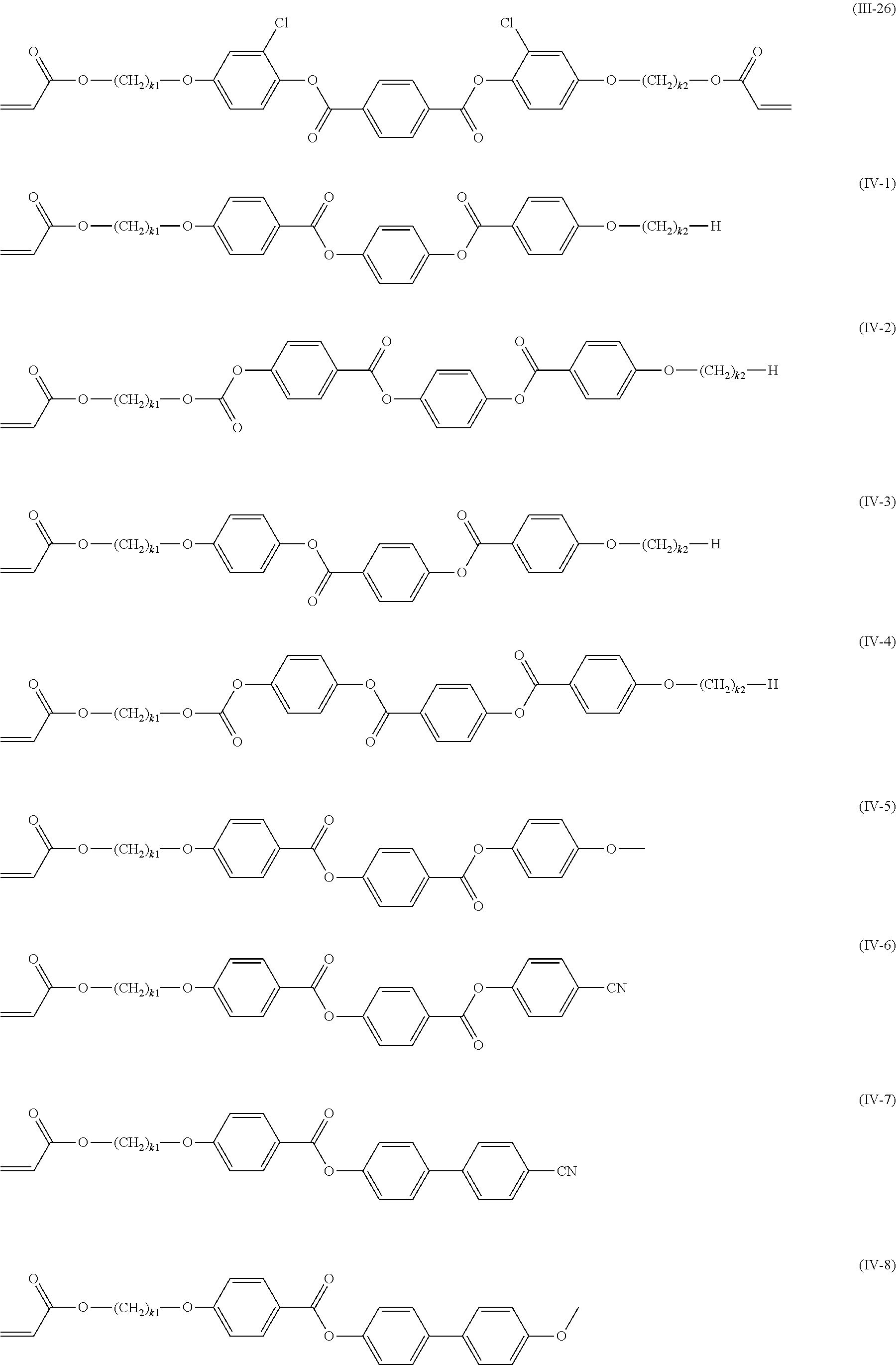

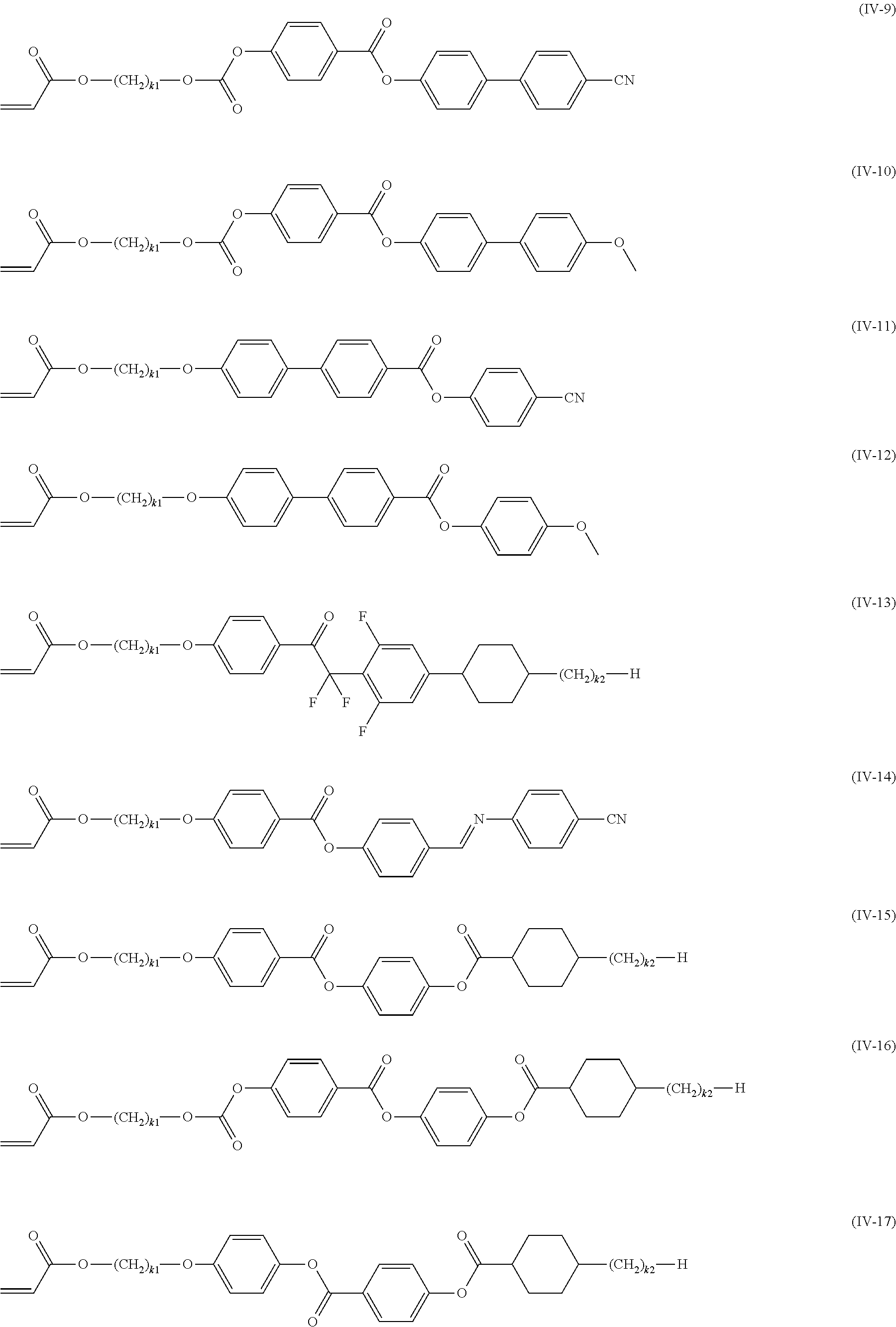

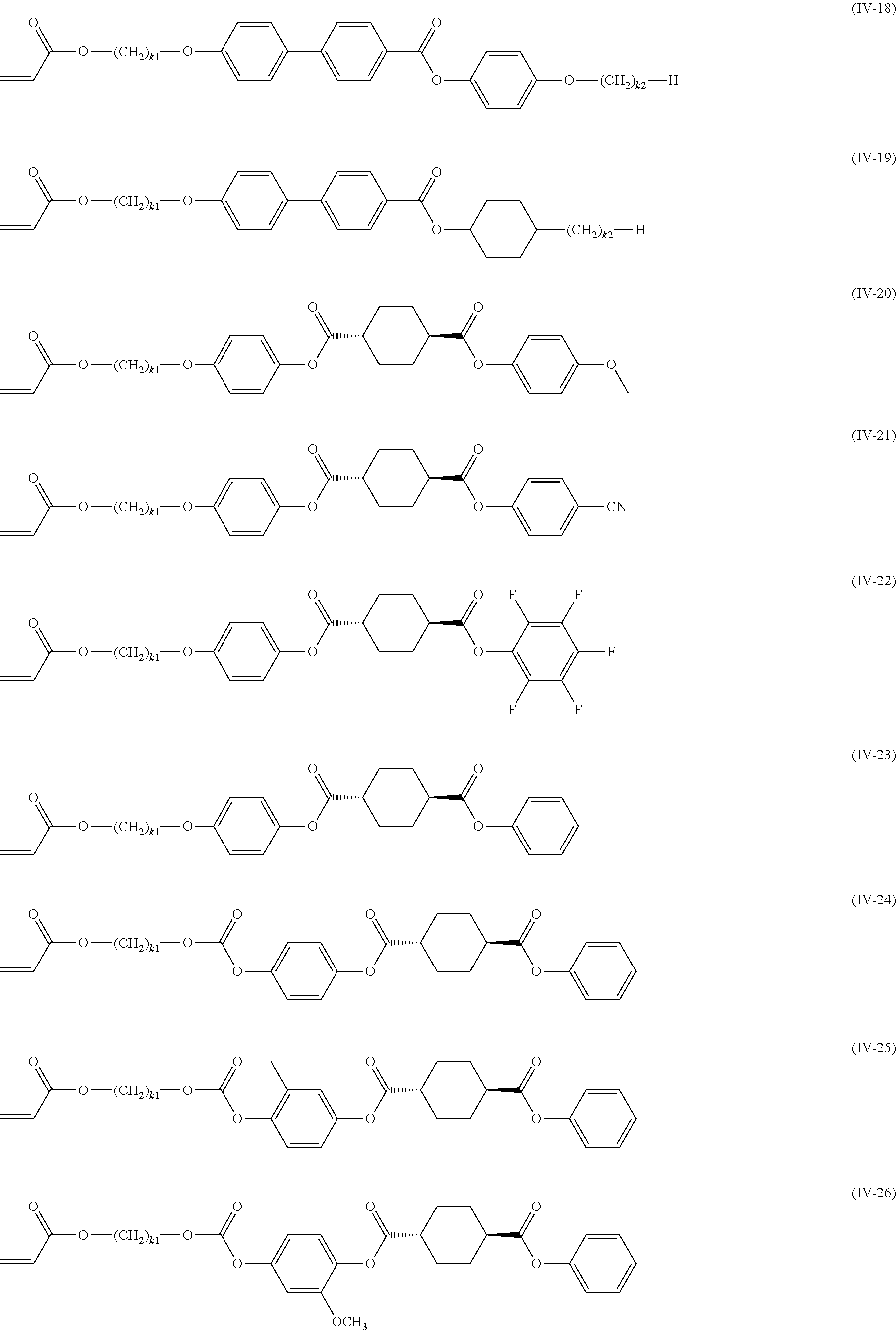

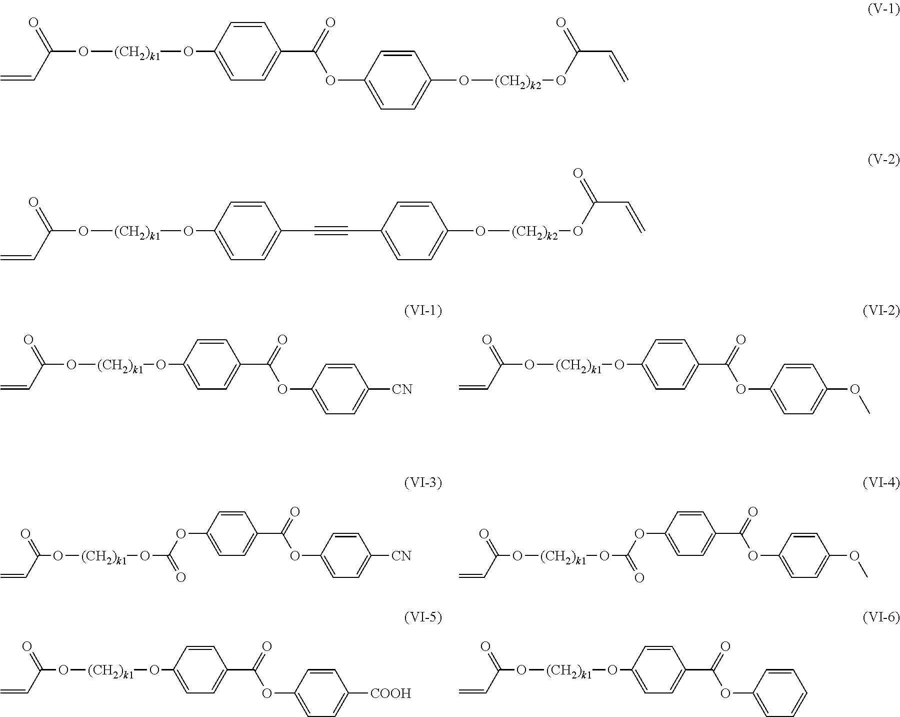

### [Solvent]

As the solvent, an organic solvent that dissolves solid contents of the composition for forming an optically anisotropic layer such as the liquid crystal compound is preferred, and when the composition for forming an optically anisotropic layer contains a polymerizable liquid crystal compound, further, an organic solvent that is inert to the polymerization reaction of the polymerizable liquid crystal compound is more preferred. Specific examples thereof include alcohol solvents such as methanol, ethanol, ethylene glycol, isopropyl alcohol, propylene glycol, methylcellosolve, butylcellosolve, propylene glycol monomethyl ether, and phenol; ester solvents such as ethyl acetate, butyl acetate, ethylene glycol methyl ether acetate, γ-butyrolactone, propylene glycol methyl ether acetate, and ethyl lactate; ketone solvents such as acetone, methyl ethyl ketone, cyclopentanone, cyclohexanone, methyl amyl ketone, and methyl isobutyl ketone; non-chlorinated aliphatic hydrocarbon solvents such as pentane, hexane, and heptane; non-chlorinated aromatic hydrocarbon solvents such as toluene and xylene; nitrile solvents such as acetonitrile; ether solvents such as tetrahydrofuran and dimethoxyethane; chlorinated hydrocarbon solvents such as chloroform and chlorobenzene; and the like. Such organic solvents may be used in combination of two or more thereof. Among them, preferred are alcohol solvents, ester solvents, ketone solvents, non-chlorinated aliphatic hydrocarbon solvents, and non-chlorinated aromatic hydrocarbon solvents.

The composition for forming an optically anisotropic layer may contain a polymerization initiator, a polymerization inhibitor, a photosensitizer, a leveling agent, a chiral agent, a reactive additive, and the like.

### [Polymerization Initiator]

The polymerization initiator is preferably a photopolymerization initiator, and more preferably a photopolymerization initiator which generates radicals by photoirradiation.

Examples of the photopolymerization initiator include benzoin compounds, benzophenone compounds, benzyl ketal compounds, α-hydroxyketone compounds, α-aminoketone compounds, triazine compounds, iodonium salts and sulfonium salts. Specific examples thereof include IRGACURE 907, IRGACURE 184, IRGACURE 651, IRGACURE 819, IRGACURE 250, and IRGACURE 369 (all manufactured by Ciba Japan K.K.); SEIKUOL BZ, SEIKUOL Z, and SEIKUOL BEE (all manufactured by Seiko Chemical Co., Ltd.); KAYACURE BP100 (manufactured by Nippon Kayaku Co., Ltd.); KAYACURE UVI-6992 (manufactured by the Dow Chemical Company); ADEKA OPTOMER SP-152, and ADEKA OPTOMER SP-170 (all manufactured by Adeka Corporation); and TAZ-A and TAZ-PP (all manufactured by Nihon Siber Hegner K.K.), and TAZ-104 (manufactured by Sanwa Chemical Co., Ltd.). Among them, preferred are α-acetophenone compounds. Examples of the α-acetophenone compounds include 2-methyl-2-morpholino-1-(4-methylsulfanylphenyl)propan-1-one, 2-dimethylamino-1-(4-morpholinophenyl)-2-benzylbutan-1-one, 2-dimethylamino-1-(4-morpholinophenyl)-2-(4-methylphenylmethyl)butane-1-one, and the like. More preferred are 2-methyl-2-morpholino-1-(4-methylsulfanylphenyl) propane-1-one, and 2-dimethylamino-1-(4-morpholinophenyl)-2-benzylbutan-1-one. Commercially available product examples of the α-acetophenone compounds include IRGACUREs 369, 379EG and 907 (all manufactured by BASF Japan Ltd.), SEIKUOL BEE (manufactured by Seiko Chemical Co., Ltd.), and the like.

The content of the polymerization initiator is usually from 0.1 parts by mass to 30 parts by mass, preferably from 0.5 parts by mass to 10 parts by mass, related to 100 parts by mass of the liquid crystal compound. It is preferred in the above range since the orientation of the liquid crystal compound is not hardly disturbed.

### [Polymerization Inhibitor]

Examples of the polymerization inhibitor include hydroquinone and hydroquinones each having a substituent such as an alkyl ether; catechols each having a substituent such as an alkyl ether, such as butylcatechol; radical scavengers such as pyrogallols and 2,2,6,6-tetramethyl-1-piperidinyloxy radicals; thiophenols; β-naphthylamines; and β-naphthols.

The content of the polymerization inhibitor in the composition for forming an optically anisotropic layer is usually from 0.1 parts by mass to 30 parts by mass, and preferably from 0.5 parts by mass to 10 parts by mass, related to 100 parts by mass of the liquid crystal compound. It is preferred in the above range since the orientation of the liquid crystal compound is not hardly disturbed.

### [Photosensitizer]

Examples of the photosensitizer include xanthones such as xanthone and thioxanthone; anthracene, and anthracenes such as anthracene having a substituent such as an alkyl ether; phenothiazine; and rubrene.

The use of the photosensitizer makes it possible to heighten the sensitivity of the reaction of the photopolymerization initiator. The content of the photosensitizer is usually from 0.1 parts by mass to 30 parts by mass, and preferably from 0.5 parts by mass to 10 parts by mass, related to 100 parts by mass of the liquid crystal compound.

### [Leveling Agent]

Examples of the leveling agent include organic modified silicone oil-based, polyacrylate-based, and perfluoroalkyl-based leveling agents. Specific examples thereof include DC3PA, SH7PA, DC11PA, SH28PA, SH29PA, SH30PA, ST80PA, ST86PA, SH8400, SH8700 and FZ2123 (all manufactured by Dow Corning Toray Co., Ltd.); KP321, KP323, KP324, KP326, KP340, KP341, X22-161A and KF6001 (all manufactured by Shin-Etsu Chemical Co., Ltd.); and TSF400, TSF401, TSF410, TSF4300, TSF4440, TSF4445, TSF-4446, TSF4452 and TSF4460 (all manufactured by Momentive Performance Materials Inc.), FLUORINERTs (registered trademark) FC-72, FC-40, FC-43 and FC-3283 (all manufactured by Sumitomo 3M Limited); MEGAFACs (registered trademark) R-08, R-30, R-90, F-410, F-411, F-443, F-445, F-470, F-477, F-479, F-482 and F-483 (all manufactured by DIC Corporation); EFTOPs (trade name) EF301, EF303, EF351 and EF352 (all manufactured by Mitsubishi Materials Electronic Chemicals Co., Ltd.); SURFLONs (registered trademark) S-381, S-382, S-383, S-393, SC-101, SC-105, KH-40 and SA-100 (all manufactured by AGC Seimi Chemical Co., Ltd.); E1830 and E5844 ((trade names) manufactured by Daikin Fine Chemical Laboratory Co., Ltd.); and BM-1000, BM-1100, BYK-352, BYK-353 and BYK-361N ((trade names) manufactured by BM Chemie GmbH). Such leveling agents may be used in any combination of two or more thereof.

It is possible to obtain a smoother optically anisotropic film by the leveling agent. Also, it is possible to control the fluidity of the composition for forming an optically anisotropic layer or adjust the crosslinking density of the optically anisotropic film in the production process of the optically anisotropic film. The content of the leveling agent is usually from 0.1 parts by mass to 30 parts by mass, and preferably from 0.1 parts by mass to 10 parts by mass, related to 100 parts by mass of the liquid crystal compound.

### [Chiral Agent]

Examples of the chiral agent include known chiral agents (for example, agents described in “Liquid Crystal Device Handbook”, Chapter 3, 4-3, Chiral Agents for TN and STN, p. 199, edited by Japan Society for the Promotion of Science, the 142nd Committee, 1989).

The chiral agent generally contains an asymmetric carbon atom, but an axially asymmetric compound or planarly asymmetric compound, which contains no asymmetric carbon atom, can be also used as the chiral agent. Examples of the axially asymmetric compound or planarly asymmetric compound include binaphthyl, helicene, paracyclophane, and derivatives of these compounds.

Specific examples thereof include compounds as described in JP-A-2007-269640, JP-A-2007-269639, JP-A-2007-176870, JP-A-2003-137887, JP-W-2000-515496, JP-A-2007-169178, and JP-W-09-506088, and preferred is Paliocolor (registered trademark) LC756 manufactured by BASF Japan Ltd.

The content of the chiral agent is usually from 0.1 parts by mass to 30 parts by mass, and preferably from 1.0 parts by mass to 25 parts by mass, related to 100 parts by mass of the liquid crystal compound. It is preferred in the above range since the orientation of the liquid crystal compound is not hardly disturbed.

### [Reactive Additive]

The reactive additive is preferably a compound having in the molecule thereof a carbon-carbon unsaturated bond and an active hydrogen reactive group. The “active hydrogen reactive group” herein means a group reactive with a group having active hydrogen such as a carboxyl group (—COOH), hydroxyl group (—OH) or amino group (—NH₂). Typical examples thereof are glycidyl, oxazoline, carbodiimide, aziridine, imide, isocyanate, thioisocyanate, maleic anhydride groups, and the like.

It is preferred that the reactive additive has at least two active hydrogen reactive groups. In this case, a plurality of the active hydrogen reactive groups may be the same as or different from each other.

The carbon-carbon unsaturated bond that the reactive additive has may be a carbon-carbon double bond, a carbon-carbon triple bond, or a combination of the two, and is preferably a carbon-carbon double bond. Among them, it is preferred that the reactive additive contains a carbon-carbon unsaturated bond as a vinyl group and/or a (meth)acrylic group. Furthermore, the reactive additive is preferably one having, as its active hydrogen reactive group (s), at least one selected from the group consisting of epoxy, glycidyl and isocyanate groups; and is particularly preferably a reactive additive having an acrylic group and an isocyanate group.

Specific examples of the reactive additive include compounds each having a (meth)acrylic group and an epoxy group, such as methacryloxy glycidyl ether and acryloxy glycidyl ether; compounds each having a (meth)acrylic group and an oxetane group, such as oxetane acrylate and oxetane methacrylate; compounds each having a (meth)acrylic group and a lactone group, such as lactone acrylate and lactone methacrylate; compounds each having a vinyl group and an oxazoline group, such as vinyl oxazoline and isopropenyl oxazoline; oligomers of a compound having a (meth)acrylic group and an isocyanate group, such as isocyanatomethyl acrylate, isocyanatomethyl methacrylate, 2-isocyanatoethyl acrylate, and 20isocyanatoethyl methacrylate, and the like. Also, other examples thereof include compounds each having a vinyl group or vinylene group and an acid anhydride, such as methacrylic anhydride, acrylic anhydride, maleic anhydride, and vinylmaleic anhydride, and the like. Among them, preferred are methacryloxy glycidyl ether, acryloxy glycidyl ether, isocyanatomethyl acrylate, isocyanatomethyl methacrylate, vinyl oxazoline, 2-isocyanatoethyl acrylate, 2-isocyanatoethyl methacrylate, and the above-mentioned oligomers. Particularly preferred are isocyanatomethyl acrylate, 2-isocyanatoethyl acrylate, and the above-mentioned oligomers.

Here, those having an isocyanate group as the active hydrogen reactive group that are more preferred as the reactive additive are specifically shown. For example, such a preferred reactive additive is represented by the following formula (Y):

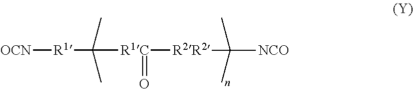

wherein

n represents an integer of 1 to 10, R^{1′}s each represent a bivalent aliphatic or alicyclic hydrocarbon group having 2 to 20 carbon atoms, or a bivalent aromatic hydrocarbon group having 5 to 20 carbon atoms; one of two R^{2′}s in each of the recurring units is a group represented by —NH— and the other is a group represented by N—C(═O)—R^{3′} wherein R^{3′} represents a hydroxyl group or a group having a carbon-carbon unsaturated bond; and

at least one of R^{3′}s in the formula (Y) is a group having a carbon-carbon unsaturated bond.

Of the reactive additives represented by the formula (Y), particularly preferred is a compound represented by the following formula (YY) in which n has the same meaning as described above (hereinafter the compound may be referred to as the “compound (YY)”):

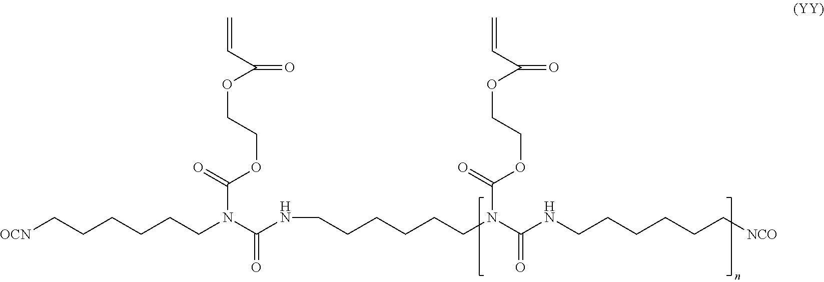

As the compound (YY), a commercially available product is usable as it is, or after being purified if necessary. The commercially available product is a product Laromer (registered trademark) LR-9000 (manufactured by BASF).

The content of the reactive additive is usually from 0.1 parts by mass to 30 parts by mass, and preferably from 0.1 parts by mass to 5 parts by mass, related to 100 parts by mass of the liquid crystal compound.

Examples of the method of coating a composition for forming an optically anisotropic layer onto a surface of the substrate, or a surface of the orientation layer formed on the surface of the substrate include the same method as the method of coating a composition for forming an orientation layer. Among them, preferred are CAP coating, inkjet coating, dip coating, slit coating, die coating, and bar-coater-used coating methods since these methods make it possible to continuously coat a composition for forming an optically anisotropic layer onto the surface of the orientation layer in a roll-to-roll manner. When the composition is coated in a roll-to-roll manner, it is also allowable to coat a composition for forming an orientation layer onto the surface of the substrate to form an orientation layer on the surface of the substrate, and further continuously coat a composition for forming an optically anisotropic layer onto the surface of the obtained orientation layer.

Examples of the method of drying the coated composition for forming an optically anisotropic layer include heating, heating and ventilation, heating and reduced pressure, and any combination of these methods. Among them, preferred is a method of heating in a retained air layer. The drying temperature is usually in the range of 40° C. to 150° C., preferably in the range of 80° C. to 140° C., and more preferably in the range of 90° C. to 130° C. When the liquid crystal compound have a solid-liquid crystal phase transition temperature at a temperature lower than the temperature in which the solvent is removable, the drying temperature is preferably a temperature in which the solvent is removable. When the liquid crystal compound have a solid-liquid crystal phase transition temperature at a temperature higher than the temperature in which the solvent is removable, the drying temperature is preferably a temperature higher than or equal to the solid-liquid crystal phase transition temperature of the liquid crystal compound.

The air layer during heating is usually constituted of air, and may be constituted of an inert gas such as nitrogen and carbon dioxide.

The drying time is usually from 10 seconds to 60 minutes, and preferably from 30 seconds to 30 minutes.

Examples of the state of the liquid crystal orientation of the liquid crystal compound include horizontal orientation, vertical orientation, hybrid orientation, oblique orientation, and the like. Preferred is vertical orientation. The expressions “horizontal”, “vertical” and the like each represent the orientation direction of a long axis of the liquid crystal compound, based on the substrate surface. For example, the “vertical orientation” denotes that the liquid crystal compound have a long axis along a direction vertical to the substrate surface.

The state of the liquid crystal orientation varies depending on the characteristics of the orientation layer and the liquid crystal compound, and the combination thereof can be arbitrarily selected. When the orientation layer is made of, for example, a material expressing horizontal orientation as orientation regulating force, the liquid crystal compound can attain horizontal orientation or hybrid orientation. When the orientation layer is made of a material expressing vertical orientation, the liquid crystal compound can attain vertical orientation or oblique orientation.

When the orientation layer is composed of an orienting polymer, the orientation regulating force is optionally adjustable in accordance with the surface state or rubbing conditions. When the orientation layer is composed of a photo-orienting polymer, the orientation regulating force is optionally adjustable in accordance with polarized-light-irradiating conditions and the like. The liquid crystal orientation is also controllable by selecting the surface tension, the liquid crystal property or the like of the liquid crystal compound.

Examples of the method of cooling the dried and formed dry coating at a rate of 6° C./sec or more include a method of bringing a surface reverse to the surface on which the orientation layer of the substrate is formed into contact with an air layer for cooling, a method of bringing a surface reverse to the surface on which the orientation layer of the substrate is formed into contact with or close to a cooling plate, a method of bringing a surface on which the dry coating is formed into contact with an air layer for cooling, and the like. Preferred is a method of bringing both a surface reverse to the surface on which the orientation layer on the substrate side is formed and a surface on which the dry coating is formed into contact with an air layer for cooling. The liquid crystal compound oriented in the vertical direction is cooled at a rate of 6° C./sec or more, whereby an optically anisotropic film excellent in transparency can be obtained. The cooling rate is preferably 6° C. to 40° C./sec.

The temperature of the dry coating before cooling at a rate of 6° C./sec or more is the drying temperature described above (usually in the range of 40° C. to 150° C., preferably in the range of 80° C. to 140° C., and more preferably in the range of 90° C. to 130° C.). Also, the temperature of the dry coating after cooling at a rate of 6° C./sec or more is preferably 0° C. to 30° C.

Examples of the air layer include nitrogen, air, and the like, and preferred is air. The temperature of the air layer is usually 0° C. to 30° C., and preferably 23° C. to 25° C. Gas in the air layer may be retained or circulated, but retained gas is preferred since temperature unevenness is hardly occurred during cooling.

The temperature of the cooling plate is usually 0° C. to 30° C., and is preferably a temperature at which dew condensation or the like is not generated by cooling.

When the cooled dry coating exhibits a liquid crystal phase such as a nematic phase, the coating exhibits a birefringence property based on mono-domain orientation. Also, by cooling the dry coating at a rate of 6° C./sec or more, mono-domain orientation is stabilized, and an optically anisotropic film with less unevenness is formed.

The temperature of the optically anisotropic film and the liquid crystal compound contained in the optically anisotropic film is preferably from 0° C. to 30° C., and more preferably from 23° C. to 25° C. By being cooled to the above temperature range, an optically anisotropic film excellent in transparency, with less orientation defect of the liquid crystal compound, can be obtained.

It is preferred that, after forming an optically anisotropic film by cooling the dry coating at a rate of 6° C./sec or more, the cooling rate is gradually lowered. Examples of the method of gradually lowering the cooling rate include the same method as described above.

The time from the start of cooling at a rate of 6° C./sec or more until gradually lowering the cooling rate and reaching a cooling rate of 0.5° C./sec is preferably 2 seconds to 10 minutes. The phrase “reaching a cooling rate of 0.5° C./sec” denotes that the temperature of the dry coating reaches an approximately constant temperature by cooling. Examples of the cooling rate include a method of bringing a thermocouple into contact, a method of observing with an infrared thermography, a method of detecting by an infrared sensor, and the like. The time described above is preferably 2 seconds to 5 minutes, more preferably 2 seconds to 1 minute, and further preferably 2 seconds to 30 seconds. In the above range, an optically anisotropic film excellent in transparency, with less orientation defect, can be obtained.

The thickness of the optically anisotropic film can be properly adjusted, depending on its use or the retardation value of the display device to be stacked, and is usually from 0.1 μm to 10 μm, and preferably from 0.2 μm to 5 μm to make the optically anisotropic film small in photoelasticity.

When the liquid crystal compound contained in the obtained optically anisotropic film is polymerizable liquid crystal compound, it is preferred to photoirradiate the optically anisotropic film. By photoirradiation, the polymerizable liquid crystal compound are polymerized to obtain a fixed optically anisotropic film. The fixed optically anisotropic film is preferred since the orientation of the liquid crystal compound is fixed so that the film is hardly affected by a birefringence change by heat.

When the polymerizable liquid crystal compound contained in the optically anisotropic film is polymerized by photoirradiation, polymerization can be performed at a low temperature, thus it is preferred in terms of heat resistance, and the wide selection range of the used substrate. The polymerization is usually conducted by the irradiation of visible rays, ultraviolet rays, or a laser ray, and is preferably conducted by the irradiation of ultraviolet rays.

The time from the start of cooling at a rate of 6° C./sec or more until photoirradiation is preferably 2 seconds to 10 minutes. The time described above is preferably 2 seconds to 5 minutes, further preferably 2 seconds to 1 minute, and further preferably 2 seconds to 30 seconds. In the above range, an optically anisotropic film with less orientation defect can be obtained.

The step (3) is preferably performed while blocking out light. Namely, from the cooling to the photoirradiation is preferably performed while blocking out light. More preferably, the step (2) is also performed while blocking out light. Namely, more preferably, from the drying of the coated composition for forming an optically anisotropic layer to the photoirradiation is performed while blocking out light. Examples of the method of blocking out light include a method of covering a film transportation zone from drying until obtaining an optically anisotropic film with a light shielding film, or with a member that completely blocks light, and the like. When the composition for forming an optically anisotropic layer contains a photopolymerization initiator, it is preferred to shield light corresponding to a photosensitive wavelength of the photopolymerization initiator, for example, it is more preferred that a short-wavelength light of 500 nm or less is not directly exposed to the film.

It is preferred that the production method of the present invention is continuously performed to a roll-form substrate. The method for continuously producing a roll-form substrate preferably contains the following steps (1) to (6):

(1) a step of forming an orientation layer on a substrate unwound from the roll;
(2) a step of coating a composition for forming an optically anisotropic layer onto a surface of the obtained orientation layer;
(3) a step of drying the coated composition for forming an optically anisotropic layer to form a dry coating;
(4) a step of cooling the obtained dry coating at a rate of 6° C./sec or more to form an optically anisotropic film, without bringing a surface on the substrate side into contact with other than a guide roll used for a film transportation and the air layer, and without bringing a surface on the composition for forming an optically anisotropic layer side into contact with other than the air layer;
(5) a step of photoirradiating the obtained optically anisotropic film; and
(6) a step of winding the substrate on the surface of which the optically anisotropic film is formed in a roll.

The roll-form optically anisotropic film obtained by the production method has small fluctuations in the liquid crystal orientation of the liquid crystal compound and excellent transparency.

The optically anisotropic film produced by the production method of the present invention (hereinafter, may be referred to as the present optically anisotropic film) is excellent in transparency in a visible light region, and can be used as a member for various display devices.

Among them, a film in which liquid crystal compound are vertically oriented has a retardation property, thus is useful as a retardation film used for converting a linearly polarized light when confirming from the oblique angle of a light emission side to a circularly polarizing light or an elliptically polarizing light, converting a circularly polarizing light or an elliptically polarizing light to a linearly polarized light, and converting the polarization direction of a linearly polarized light.

The present optically anisotropic film may be used separately from the substrate or the substrate and the orientation layer.

The present optically anisotropic film not having the substrate, or the substrate and the orientation layer, is usually combined with other member such as a polarization film via an adhesive.

Examples of the method for combining with other member via an adhesive include a method of bonding the present optically anisotropic film not having the substrate, or the substrate and the orientation layer, onto other member using an adhesive; a method of bonding the present optically anisotropic film formed on the surface of the orientation layer formed on the surface of the substrate, onto other member using an adhesive, then removing the substrate, or the substrate and the orientation layer; and the like. At this time, the adhesive may be coated onto the present optically anisotropic film, and may be coated onto other member.

The present optically anisotropic film may be laminated in a plural number, and may be combined with other film. When the present optically anisotropic film with different orientation states of the liquid crystal compound is laminated in a plural number, or the present optically anisotropic film is combined with other film, the laminated body can be used as a viewing angle compensating film, a viewing angle enlarging film, an anti-reflection film, a polarizing plate, a circularly polarizing plate, an elliptically polarizing plate, or a brightness enhancement film.

The present optically anisotropic film can be changed in optical property in accordance with the orientation state of the liquid crystal compound, and is usable as a retardation film for various liquid crystal display devices in a vertical alignment (VA) mode, an in-plane switching (IPS) mode, an optically compensated bend (OCB) mode, a twisted nematic (TN) mode, a super twisted nematic (STN) mode, and the like. Among them, the present optically anisotropic film is preferred as a retardation film for an in-plane switching (IPS) liquid crystal display device.

When the refractive index in the in-plane slow axis direction thereof is represented by nₓ, that in the direction orthogonal to the in-plane slow axis (the fast axis direction) by n_{y}, and that in the thickness direction thereof by n_{z}, the present optically anisotropic films can be classified as follows. The present optically anisotropic film is particularly preferably used as a positive C plate.

a positive A plate in which nₓ>n_{y}≈n_{z},
a negative C plate in which nₓ≈n_{y}>n_{z},
a positive C plate in which nₓ≈n_{y}<n_{z}, and
a positive O plate and a negative O plate in which nₓ≠n_{y}≠n_{z}

When the present optically anisotropic film is used as a positive C plate, it is advisable to adjust the front retardation value Re (549) into the range of 0 nm to 10 nm, and preferably usually into that of 0 nm to 5 nm, and adjust the retardation value Rₜₕ in thickness direction usually into the range of −10 nm to −300 nm, and preferably into that of −20 nm to −200 nm. The front retardation value Re (549) is preferably properly selected in accordance with properties of a liquid crystal cell.

The retardation value Rₜₕ in thickness direction retardation value Rₜₕ, which means the refractive index anisotropy of the optically anisotropic film in the thickness direction, can be calculated from the retardation value R₅₀ measured in the state of inclining the in-plane fast axis at 50 degrees to be rendered an inclined axis, and the in-plane retardation value R₀. Specifically, the retardation value Rₜₕ in thickness direction can be calculated by obtaining nₓ, n_{y} and n_{z} through the following equations (9) to (11), from the in-plane retardation value R₀, the retardation value R₅₀, which is measured in the state of inclining the fast axis at 50 degrees to be rendered an inclined axis, the thickness d of the film, and the average refractive index n₀ of the film; and then substituting these values into an equation (8).

Rₜₕ=[(nₓ+n_{y})/2−n_{z}]×d (8)

R₀=(nₓ−n_{y})×d (9)

R₅₀=(nₓ−n_{y}′)×d/cos(φ) (10)

(nₓ+n_{y}+n_{z})/3=n₀ (11)

wherein

φ=sin⁻¹ [sin(50°)/n₀]

n_{y}′=n_{y}×n_{z}/[n_{y}²×sin²(φ)+n_{z}²×cos²(φ)]^{1/2}

The present optically anisotropic film is useful as a member which constitutes a polarizing plate. The polarizing plate of the present invention is a plate containing at least one of the present optically anisotropic films, and may be contained as a retardation film.

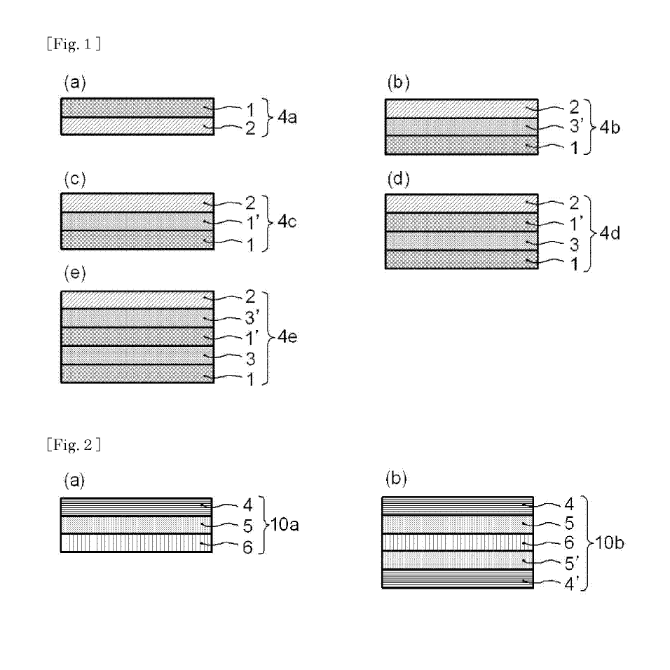

Specific examples of the polarizing plate include polarizing plates shown in FIGS. 1(a) to 1(e). The polarizing plate 4a shown in FIG. 1(a) is a polarizing plate in which a retardation film 1 and a polarization film 2 are laminated directly onto each other. The polarizing plate 4b shown in FIG. 1(b) is a polarizing plate in which a retardation film 1 and a polarization film 2 are stuck through an adhesive layer 3′. The polarizing plate 4c shown in FIG. 1(c) is a polarizing plate in which retardation films 1 and 1′ are laminated onto each other and further a polarization film 2 is laminated onto the retardation film 1′. The polarizing plate 4d illustrated in FIG. 1(d) is a polarizing plate in which retardation films 1 and 1′ are bonded onto each other through an adhesive layer 3, and further a polarization film 2 is laminated onto the retardation film 1′. The polarizing plate 4e shown in FIG. 1(e) is a polarizing plate in which retardation films 1 and 1′ are bonded onto each other through an adhesive layer 3, and further the retardation film 1′ and a polarization film 2 are bonded onto each other through an adhesive layer 3′. The “adhesive” denotes a generic name of any adhesive and/or any pressure-sensitive adhesive.

It is sufficient for the polarization film 2 to be a film having a polarizing function. Examples of the film include a drawn film to which a dye having absorption anisotropy is adsorbed, a film onto which a dye having absorption anisotropy is coated, and the like. Examples of the dye having absorption anisotropy include dichroic dyes such as iodine and azo compounds.

Examples of the drawn film to which a dye having absorption anisotropy is adsorbed include a film obtained by adsorbing a dichroic dye to a polyvinyl alcohol-based film, and then drawing the resultant; a film obtained by drawing a polyvinyl alcohol-based film, and then adsorbing a dichroic dye to the resultant; and the like.

Examples of the film onto which a dye having absorption anisotropy is coated include a film obtained by coating a composition containing a dichroic dye having liquid crystal property, or coating a composition containing a dichroic dye and polymerizable liquid crystal compound, and the like.

The film having a polarizing function preferably has a protection film on one surface or both surfaces thereof. Examples of the protection film include those identical to the above-mentioned substrates.

Specific examples of the drawn film to which a dye having absorption anisotropy is adsorbed include polarizing plates described in Japanese Patent Nos. 3708062 and 4432487.

Specific examples of the film onto which a dye having absorption anisotropy is coated include polarization films described in JP-A-2012-33249 and the like.

The adhesive that forms the adhesive layers 3 and 3′ is preferably an adhesive with high transparency and excellent heat resistance. Examples of such adhesive include acrylic-based, epoxy-based and urethane-based adhesives.

The present optically anisotropic film is useful as a member which constitutes a display device. Examples of the display device include a liquid crystal display device equipped with a liquid crystal panel in which the present optically anisotropic film and a liquid crystal panel are stuck with each other, and an organic electroluminescence (hereinafter also referred to as EL) display device equipped with an organic EL panel in which the present optically anisotropic film and a luminous layer are stuck with each other. A liquid crystal display device will be described as an embodiment of the display device equipped with the present optically anisotropic film.

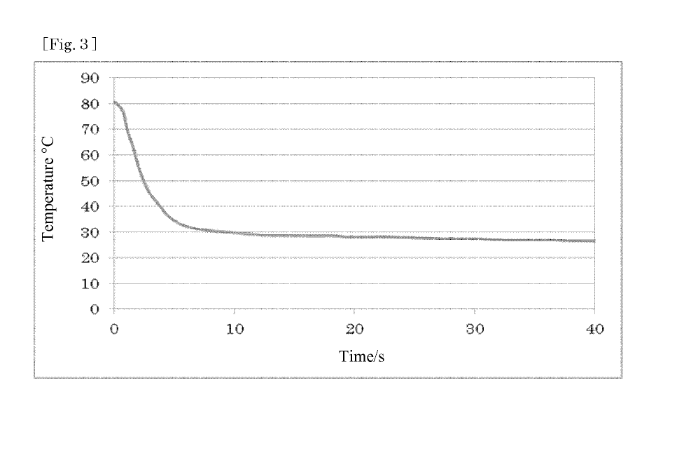

Examples of the liquid crystal display device include liquid crystal display devices 10a and 10b shown in FIGS. 2(a) and 2(b), respectively. In the liquid crystal display device 10a shown in FIG. 2(a), the polarizing plate 4 of the present invention and a liquid crystal panel 6 are stuck through an adhesion layer 5. In the liquid crystal display device 10b shown in FIG. 2(b), the polarizing plate 4 of the present invention is stuck to one surface of a liquid crystal panel 6 through an adhesion layer 5 while a polarizing plate 4′ of the present invention is stuck to the other surface of the liquid crystal panel 6 through an adhesion layer 5′. Electrodes not shown are used in these liquid crystal display devices to apply a voltage to their liquid crystal panel to change the orientation of liquid crystal molecules. In this way, a monochrome display can be realized.

### EXAMPLES

Hereinafter, the present invention will be more specifically described by way of examples, but is not limited to the following examples. In the examples, the symbol “%” and the word “part(s)” denote “% by mass” and “part(s) by mass”, respectively, unless otherwise specified.

### [Preparation of Composition for Forming Orientation Layer]

Composition of a composition for forming an orientation layer is shown in Table 1. N-methyl-2-pyrrolidone, 2-butoxyethanol and ethylcyclohexane were added to a commercially available orienting polymer, SUNEVER SE-610 (manufactured by Nissan Chemical Industries, Ltd.) to yield a composition for forming an orientation layer (1).

TABLE 1

| | Solid | | | |
|---|---|---|---|---|
| | content of | N-Methyl-2- | 2-Butoxy- | Ethylcyclo- |
| | SE-610 | pyrrolidone | ethanol | hexane |
| Composition for | 1.0% | 71.8% | 18.1% | 9.1% |
| forming an | | | | |
| orientation layer (1) | | | | |

The value in Table 1 represents the proportion of the content of each component in the total amount of the prepared composition.

About the SE-610, the solid content was obtained by conversion from the concentration described in a delivery specification thereof.

### [Preparation of Composition for Forming Optically Anisotropic Layer]

Composition of a composition for forming an optically anisotropic layer is shown in Table 2. The individual components were mixed with each other, and the resultant solution was stirred at 60° C. for 1 hour, and then cooled to room temperature to yield a composition for forming an optically anisotropic layer (1).

TABLE 2

| | Polymerizable | | | | |
|---|---|---|---|---|---|
| | liquid crystal | Photopolymerization | Leveling | Reactive | |
| | compound | initiator | agent | additive | Solvent |
| Composition for | LC242 | Irg907 | BYK-361N | LR9000 | PGMEA |
| forming an | (19.2%) | (0.5%) | (0.1%) | (1.1%) | (79.1%) |
| optically | | | | | |
| anisotropic | | | | | |
| layer (1) | | | | | |

The value in parentheses in Table 2 represents the proportion of the content of each component in the total amount of the prepared composition.

In Table 2, LR9000 represents Laromer (registered trademark) LR-9000 manufactured by BASF Japan Ltd.; Irg907 represents IRGACURE 907 manufactured by BASF Japan Ltd.; BYK361N represents a leveling agent manufactured by BYK Japan K.K.; LC242 represents polymerizable liquid crystal compound manufactured by BASF represented by the following formula; and PGMEGA represents propylene glycol-1-monomethyl ether-2-acetate.

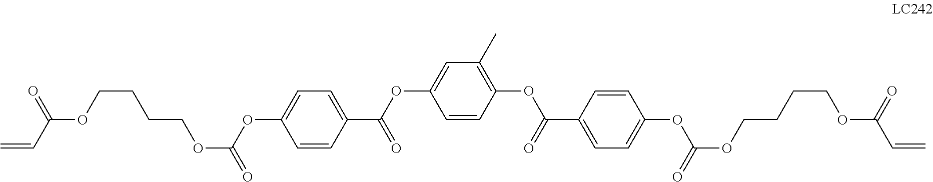 [SMILES: C=CC(=O)OCCCCOC(=O)Oc1ccc(C(=O)Oc2ccc(OC(=O)c3ccc(OC(=O)OCCCCOC(=O)C=C)cc3)c(C)c2)cc1]

### Example 1

The plasma was generated at 1.3 kV in an atmosphere containing nitrogen and oxygen (ratio by volume of nitrogen to oxygen=99.9:0.1), using a normal-pressure plasma surface-treating machine (roll direct head type AP-TO4S-R890, manufactured by Sekisui Chemical Co., Ltd.), to treat a surface of a roll-form cycloolefin polymer film (ZF-14, manufactured by Zeon Corporation) over a length of 100 m. The composition for forming an orientation layer (1) was coated onto the surface of cycloolefin polymer film subjected to the plasma treatment, using a die coater. The resultant workpiece was carried to a drying furnace at 90° C. to be dried for 1 minute. In this way, an orientation layer was yielded. The composition for forming an optically anisotropic layer (1) was coated onto the surface of the resultant orientation layer, using a die coater. The resultant workpiece was carried to a drying furnace at 80° C. to be dried for 1 minute. The dried workpiece was taken out from the drying furnace and cooled at a rate of 10° C./sec. The cooling rate was gradually lowered from the start of cooling, and reached 0.5° C./sec at a time of the lapse of 10 seconds. After 50 seconds from the start of cooling, the temperature of the dry coating reached 23° C. After 50 seconds from the start of cooling, ultraviolet rays were irradiated at an illuminance of 160 W/cm at a wavelength of 365 nm to perform polymerization, using a high-pressure mercury lamp (manufactured by GS Yuasa Corporation), to yield a roll-form optically anisotropic film (1).

The temperature change of the dry coating is shown in Table 3. The vertical axis shows the temperature (° C.) of the dry coating, and the horizontal axis represents the time (sec).

### Comparative Example 1

An optically anisotropic film (2) was yielded in the same conditions as in Example 1 except that the cooling rate was changed to 2° C./sec by cooling while bringing a heated metal plate into contact with the back of the substrate.

### [Transparency Evaluation]

The haze value of each of the optically anisotropic films (1) and (2) was measured by a double beam method, using a haze meter (model: HZ-2) manufactured by Suga Test Instruments Co., Ltd. The results are shown in Table 3.

### [Optical Property Measurement]

The retardation value of the optically anisotropic films (1) and (2) yielded above was measured using a measuring instrument (KOBRA-WR, manufactured by Oji Scientific Instruments). The measurement was made while the incident angle of light into the sample was varied, and the orientation direction of the polymerizable liquid crystal compound was confirmed. The results are shown in Table 3.

TABLE 3

| | Orientation | Haze (%) |
|---|---|---|
| Example 1 | Vertical | 0.15 |
| | orientation | |
| Comparative | Vertical | 3.37 |
| Example 1 | orientation | |

The optically anisotropic films yielded in Examples were excellent in transparency.

### INDUSTRIAL APPLICABILITY

According to the present invention, an optically anisotropic film excellent in transparency can be produced.

### DESCRIPTION OF REFERENCE SIGNS

1, 1′: Retardation film
2, 2′: Polarization film
3, 3′: Adhesive layer
4a, 4b, 4c, 4d, 4e, 4, 4′: Polarizing plate
5, 5′: Adhesion layer
6: Liquid crystal panel
10a, 10b: Liquid crystal display device

1. A method for producing an optically anisotropic film comprising the following steps (1) to (3):
(1) a step of coating a composition for forming an optically anisotropic layer onto a surface of a substrate, or a surface of an orientation layer formed on the surface of the substrate;
(2) a step of drying the coated composition for forming an optically anisotropic layer to form a dry coating; and
(3) a step of cooling the dry coating at a rate of 6° C./sec or more to form an optically anisotropic film.

2. The method for producing an optically anisotropic film according to claim 1, comprising, after forming an optically anisotropic film by cooling the dry coating at a rate of 6° C./sec or more, gradually lowering the cooling rate.

3. The method for producing an optically anisotropic film according to claim 1, further comprising a step of (4) a step of photoirradiating the optically anisotropic film.

4. The method for producing an optically anisotropic film according to claim 1, wherein the time from the start of cooling at a rate of 6° C./sec or more until gradually lowering the cooling rate and reaching a cooling rate of 0.5° C./sec is 2 seconds to 10 minutes.

5. The method for producing an optically anisotropic film according to claim 1, wherein the substrate is a roll-form substrate, and the steps (1) to (3) are continuously performed.

6. The method for producing an optically anisotropic film according to claim 1, wherein the steps (2) and (3) are performed while blocking out light.

7. The method for producing an optically anisotropic film according to claim 5, wherein cooling was performed by bringing a surface reverse to the surface on which the orientation layer of the substrate is formed into contact with only an air layer and a guide roll, and cooling was performed by bringing a surface of the dry coating into contact with only an air layer.

8. An optically anisotropic film obtained by performing the following steps (1) to (3):
(1) a step of coating a composition for forming an optically anisotropic layer onto a surface of a substrate, or a surface of an orientation layer formed on the surface of the substrate;
(2) a step of drying the coated composition for forming an optically anisotropic layer to form a dry coating; and
(3) a step of cooling the dry coating at a rate of 6° C./sec or more to form an optically anisotropic film.

9. The optically anisotropic film according to claim 8, the film having a retardation property.

10. The optically anisotropic film according to any of claim 8, the film being for an in-plane switching (IPS) liquid crystal display device.

11. A polarizing plate having the optically anisotropic film according to claim 8.

12. A display device comprising the optically anisotropic film according to claim 8.
